(19) United States
(12) Patent Application Publication
(10) Pub. No.: US 2009/0291198 A1
(43) Pub. Date: Nov. 26, 2009

(54) COATING TREATMENT METHOD, COMPUTER-READABLE STORAGE MEDIUM, AND COATING TREATMENT APPARATUS

(75) Inventors: Kousuke Yoshihara, Koshi-shi (JP); Katsunori Ichino, Koshi-shi (JP); Tomohiro Iseki, Koshi-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/467,642

(22) Filed: May 18, 2009

(30) Foreign Application Priority Data
May 20, 2008 (JP) 2008-131495

(51) Int. Cl. B05D 3/10; B05B 12/00

(52) U.S. Cl. 427/8; 427/299; 118/663

(57) ABSTRACT

The present invention is a coating treatment method of applying a coating solution containing an organic solvent onto a substrate, the method including: a first step of supplying a treatment solution having a first surface tension to a central portion of the substrate; a second step of supplying a solvent for the coating solution to a central portion of the treatment solution supplied in the first step, the solvent having a second surface tension lower than the first surface tension; and a third step of supplying the coating solution to a central portion of the solvent supplied in the second step while rotating the substrate to diffuse the treatment solution and the solvent on the substrate to thereby diffuse the coating solution on an entire surface of the substrate.

### BACKGROUND OF THE INVENTION

1. Field of the Invention

The present invention relates to a coating treatment method of applying a coating solution containing an organic solvent onto a substrate, for example, a semiconductor wafer or the like, a computer-readable storage medium, and a coating treatment apparatus.

2. Description of the Related Art

In a photolithography step in a manufacturing process of a semiconductor device, for example, a resist coating treatment of applying a resist solution onto, for example, a semiconductor wafer (hereinafter, referred to as a “wafer”) to form a resist film, exposure processing of exposing a predetermined pattern to light on the resist film, a developing treatment of developing the exposed resist film and so on are performed in sequence to form a predetermined resist pattern on the wafer.

In the above-described resist coating treatments, a so-called spin coating method is frequently used in which a resist solution is supplied from a nozzle to a central portion on the front surface of a rotated wafer and the centrifugal force is utilized to diffuse the resist solution on the wafer to thereby apply the resist solution on the front surface of the wafer.

In this spin coating method, a so-called prewet method in which, for example, a solvent for the resist solution is supplied onto the wafer to facilitate diffusion of the resist solution is performed before the resist solution is supplied. However, when the prewet method was performed, the resist solution has sometimes not diffused concentrically with the wafer but irregularly diffused outward in the shape of bars at a peripheral portion of the wafer, resulting in the appearance of radiated long acute bars.

Hence, a method, which is made by improving this prewet method, of supplying a mixed solution of a solvent for a resist solution and a volatilization inhibitor inhibiting volatilization of the solvent, for example, to a front surface of a wafer and diffusing the mixed solution on the entire surface of the wafer, and then supplying a resist solution onto a central portion of the wafer while rotating the wafer to thereby diffuse the resist solution on the entire surface of the wafer is disclosed as a method of uniformly applying a resist solution (Japanese Patent Application Laid-open No. 2003-59825).

### SUMMARY OF THE INVENTION

However, in the above-described conventional method, the volatilization inhibitor contains, for example, water, so that when the resist solution is supplied onto the wafer, the resist solution may be solidified due to reaction between the resist solution and the water. A portion of the resist solution solidified as described above remaining in the resist solution causes a defect of a resist pattern which will be formed thereafter. In particular, miniaturization of semiconductor devices progresses recently and the resist pattern is miniaturized, so that the solidified portion of the resist solution prominently appears as a defect. Accordingly, to suppress such a defect, it is necessary to turn the solidified portion of the resist solution out of the wafer in the conventional method. To this end, however, a large amount of resist solution needs to be supplied.

The present invention has been developed in consideration of the above point, and its object is to reduce the supply amount of a coating solution while uniformly applying the coating solution within a substrate, when applying a coating solution containing an organic solvent onto the substrate.

To achieve the above object, the present invention is a coating treatment method of applying a coating solution containing an organic solvent onto a substrate, the method including: a first step of supplying a treatment solution having a first surface tension to a central portion of the substrate; a second step of subsequently supplying a solvent for the coating solution to a central portion of the treatment solution supplied in the first step, the solvent having a second surface tension lower than the first surface tension; and a third step of subsequently supplying the coating solution to a central portion of the solvent supplied in the second step while rotating the substrate to diffuse the treatment solution and the solvent on the substrate to thereby diffuse the coating solution on an entire surface of the substrate.

According to the present invention, the treatment solution supplied onto the substrate in the first step has a surface tension higher than that of the solvent subsequently supplied onto the treatment solution in the second step, so that the treatment solution suppresses diffusion of the solvent and the treatment solution diffuses on the substrate ahead of the solvent in the diffusion direction (ahead in the radial direction of the substrate) at all times. Further, since the treatment solution has a high surface tension, the treatment solution supplied onto the substrate in the first step diffuses concentrically with the substrate. Thus, the treatment solution and the solvent diffuse in this order concentrically with the substrate. Thereafter, the coating solution is supplied onto the solvent in the third step, so that the coating solution is led by the solvent to smoothly diffuse on the substrate. Accordingly, the treatment solution, the solvent, and the coating solution diffuse in this order concentrically with the substrate, and the coating solution is led by the solvent to smoothly diffuse on the substrate. This makes it possible to apply the coating solution uniformly within the substrate and reduce the supply amount of the coating solution as compared to the case where the coating solution does not diffuse concentrically with the substrate as in the prior art. Further, since the solvent exists between the treatment solution and the coating solution, the coating solution is never mixed with the treatment solution. Accordingly, even when pure water is used for the treatment solution, solidification of the coating solution as in the prior art can be suppressed and the supply amount of the coating solution can be further reduced.

According to the present invention, it is possible to reduce the supply amount of the coating solution while applying the coating solution uniformly within the substrate, when applying a coating solution containing an organic solvent onto the substrate.

Before the coating solution is applied onto the substrate, a solvent for the coating solution is supplied onto an inspection substrate, the coating solution is then supplied to a central portion of the solvent supplied on the inspection substrate while rotating the inspection substrate, and a way that the coating solution diffuses on the inspection substrate is inspected, and if that the coating solution does not diffuse concentrically with the inspection substrate is verified, the first to third steps may be performed.

The present invention according to another aspect is a computer-readable storage medium storing a program running on a computer of a control unit which controls a coating treatment apparatus in order to cause the coating treatment apparatus to execute the coating treatment method.

The present invention according to still another aspect is a coating treatment apparatus for applying a coating solution containing an organic solvent onto a substrate, the apparatus including: a treatment solution nozzle for supplying a treatment solution having a first surface tension to the substrate; a solvent nozzle for supplying a solvent for the coating solution to the substrate, the solvent having a second surface tension lower than the first surface tension; a coating solution nozzle for supplying the coating solution to the substrate; and a rotating and holding unit for holding the substrate and rotating the substrate at a predetermined speed. The apparatus further includes a control unit for controlling the treatment solution nozzle, the solvent nozzle, the coating solution nozzle, and the rotating and holding unit to execute a first step of supplying the treatment solution having the first surface tension to a central portion of the substrate; a second step of subsequently supplying the solvent for the coating solution having the second surface tension lower than the first surface tension to a central portion of the treatment solution supplied in the first step; and a third step of subsequently supplying the coating solution to a central portion of the solvent supplied in the second step while rotating the substrate to diffuse the treatment solution and the solvent on the substrate to thereby diffuse the coating solution on an entire surface of the substrate.

### BRIEF DESCRIPTION OF THE DRAWINGS

FIG. 1 is a longitudinal sectional view showing the outline of a configuration of a resist coating apparatus according to this embodiment;

FIG. 2 is a transverse sectional view showing the outline of the configuration of the resist coating apparatus;

FIG. 3 is a flowchart showing main steps of a coating treatment process;

FIG. 4 is a graph showing the numbers of rotations of a wafer and supply timings of a pure water, a solvent and a resist solution in the steps of the coating treatment process;

FIG. 5 is an explanatory view schematically showing the state of a solution film on the wafer in each of the steps of the coating treatment process;

FIG. 6 is an explanatory view schematically showing the state of a solution film on the wafer in each of the steps of the coating treatment process;

FIG. 7 is a longitudinal sectional view showing the outline of a configuration of a resist coating apparatus according to another embodiment;

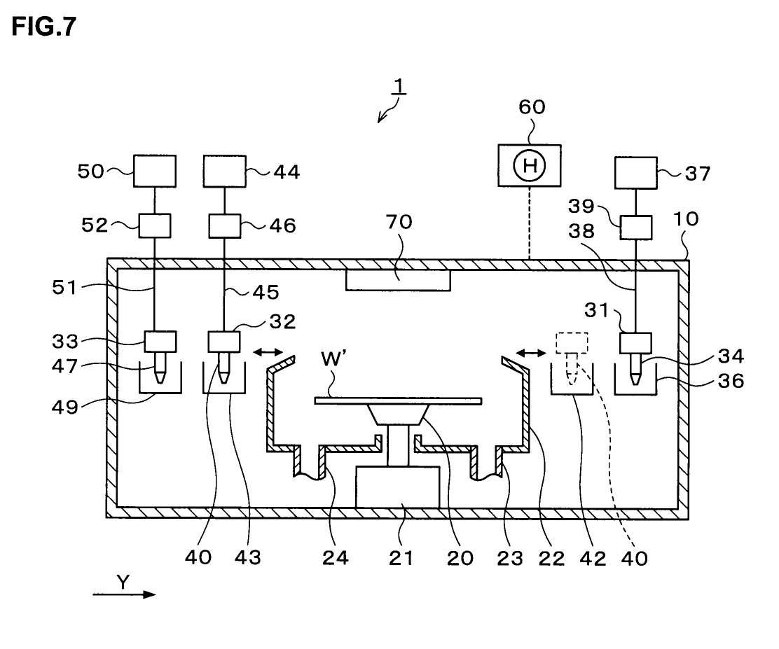

FIG. 8 is a flowchart explaining inspection processing steps for an inspection wafer and coating treatment steps for a wafer; and

FIG. 9 is an explanatory view showing the way that the resist solution diffuses on an inspection wafer.

### DETAILED DESCRIPTION OF THE INVENTION

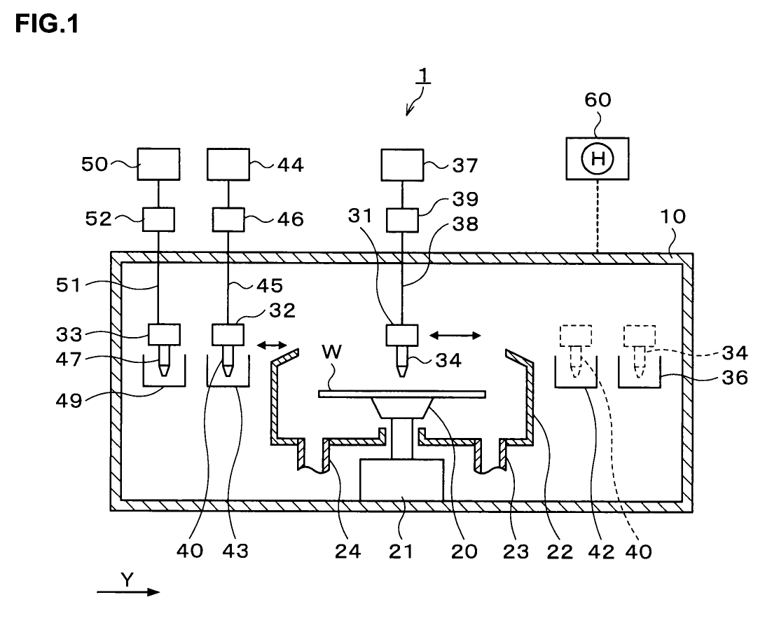

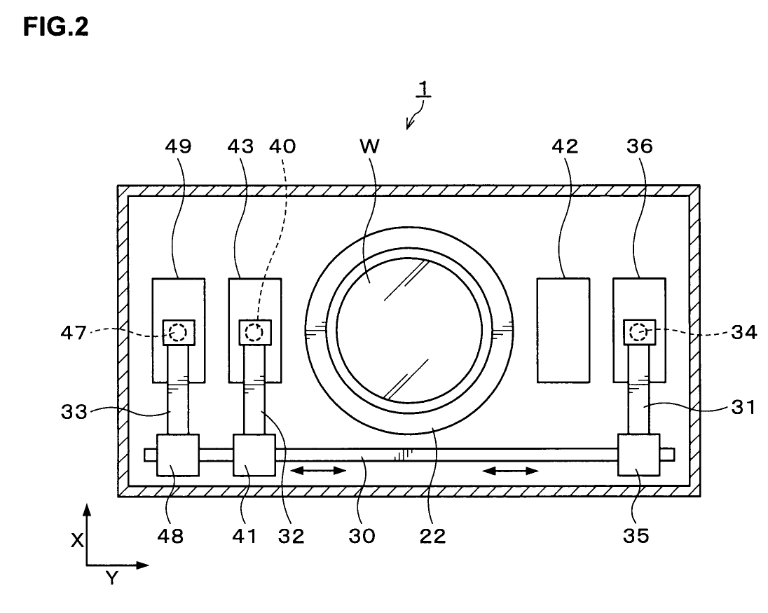

Hereinafter, a preferred embodiment of the present invention will be described. FIG. 1 is an explanatory view showing the outline of a configuration of a resist coating apparatus 1 as a coating treatment apparatus according to this embodiment, and FIG. 2 is a transverse sectional view showing the outline of the configuration of the resist coating apparatus 1. Note that in this embodiment, a resist solution containing an organic solvent, for example, an ArF resist is used as the coating solution.

The resist coating apparatus 1 has a treatment container 10 as shown in FIG. 1, and a spin chuck 20 as a rotating and holding unit which holds and rotates the wafer W as a substrate thereon is provided at a central portion in the treatment container 10. The spin chuck 20 has a horizontal upper surface, and the upper surface is provided with, for example, a suction port (not shown) which sucks the wafer W. Suction through the suction port allows the wafer W to be suction-held on the spin chuck 20.

The spin chuck 20 has a chuck drive mechanism 21 equipped with, for example, a motor or the like and can be rotated at a predetermined speed by the chuck drive mechanism 21. Further, the chuck drive mechanism 21 is provided with a raising and lowering drive source such as a cylinder so that the spin chuck 20 is vertically movable.

Around the spin chuck 20, a cup 22 is provided which receives and collects liquid splashing or dropping from the wafer W. A drain pipe 23 for draining the collected liquid and an exhaust pipe 24 for exhausting the atmosphere in the cup 22 are connected to the bottom surface of the cup 22.

As shown in FIG. 2, on the side of the negative direction in an X-direction (the lower direction in FIG. 2) of the cup 22, a rail 30 is formed which extends along a Y-direction (the right-to-left direction in FIG. 2). The rail 30 is formed, for example, from the outside on the negative direction side in the Y-direction of the cup 22 (the left direction in FIG. 2) to the outside on the positive direction side in the Y-direction (the right direction in FIG. 2). To the rail 30, for example, three arms 31, 32 and 33 are attached.

On the first arm 31, a resist solution nozzle 34 as a coating solution nozzle which supplies the resist solution is supported as shown in FIG. 1 and FIG. 2. The first arm 31 is movable on the rail 30 by means of a nozzle drive unit 35 shown in FIG. 2. This allows the resist solution nozzle 34 to move from a waiting section 36 provided at the outside on the positive direction side in the Y-direction of the cup 22 to a position above a central portion of the wafer W in the cup 22. Further, the first arm 31 freely rises and lowers by means of the nozzle drive unit 35 to be able to adjust the height of the resist solution nozzle 34.

To the resist solution nozzle 34, a supply pipe 38 communicating with a resist solution supply source 37 is connected as shown in FIG. 1. In the resist solution supply source 37, a resist solution is stored. The supply pipe 38 is provided with a supply equipment group 39 including a valve, a flow regulator and so on for controlling the flow of the resist solution.

On the second arm 32, a solvent nozzle 40 is supported which supplies a solvent for the resist solution. The second arm 32 is movable on the rail 30 by means of a nozzle drive unit 41 shown in FIG. 2. This allows the solvent nozzle 40 to move from a waiting section 42 provided at the outside on the positive direction side in the Y-direction of the cup 22, pass through a position above the central portion of the wafer W in the cup 22 to a waiting section 43 provided at the outside on the negative direction side in the Y-direction of the cup 22. The waiting section 42 is provided between the outside on the negative direction side in the Y-direction of the cup 22 and the waiting section 36. The second arm 32 freely rises and lowers by means of the nozzle drive unit 41 to be able to adjust the height of the solvent nozzle 40. Note that as the solvent for the resist solution, for example, OK73 thinner (a product manufactured by Tokyo Ohka Kogyo Co., Ltd.) is used.

To the solvent nozzle 40, a supply pipe 45 communicating with a solvent supply source 44 is connected as shown in FIG. 1. In the solvent supply source 44, the solvent for the resist solution is stored. The supply pipe 45 is provided with a supply equipment group 46 including a valve, a flow regulator and so on for controlling the flow of the solvent.

On the third arm 33, a pure water nozzle 47 as a treatment solution nozzle is supported which supplies a treatment solution having a surface tension higher than that of the solvent, for example, pure water. The third arm 33 is movable on the rail 30 by means of a nozzle drive unit 48 shown in FIG. 2. This allows the pure water nozzle 47 to move from a waiting section 49 provided on the negative direction side in the Y-direction of the waiting section 43 for the solvent nozzle 40 to a position above the central portion of the wafer W in the cup 22. Further, the third arm 33 freely rises and lowers by means of the nozzle drive unit 48 to be able to adjust the height of the pure water nozzle 47.

To the pure water nozzle 47, a supply pipe 51 communicating with a pure water supply source 50 is connected as shown in FIG. 1. In the pure water supply source 50, pure water is stored. The supply pipe 51 is provided with a supply equipment group 52 including a valve, a flow regulator and so on for controlling the flow of the pure water.

Though the resist solution nozzle 34 for supplying the resist solution, the solvent nozzle 40 for supplying the solvent, and the pure water nozzle 47 for supplying the pure water are supported on the discrete arms in the above configuration, they may be supported on the same arm, and the movements and the supply timings of the resist solution nozzle 34, the solvent nozzle 40, and the pure water nozzle 47 may be controlled by controlling the movement of the arm.

The operations of a drive system such as the above-described rotation operation and vertical operation of the spin chuck 20, the movement operation of the resist solution nozzle 34 by the nozzle drive unit 35, the supply operation of the resist solution from the resist solution nozzle 34 by the supply equipment group 39, the movement operation of the solvent nozzle 40 by the nozzle drive unit 41, the supply operation of the solvent from the solvent nozzle 40 by the supply equipment group 46, the movement operation of the pure water nozzle 47 by the nozzle drive unit 48, the supply operation of the pure water from the pure water nozzle 40 by the supply equipment group 52 and so on are controlled by a control unit 60. The control unit 60 is composed of, for example, a computer including a CPU and a memory and can realize the resist coating treatment in the resist coating apparatus 1, for example, by executing programs stored in the memory. Note that various programs to realize the resist coating treatment in the resist coating apparatus 1 are ones which are recorded, for example, on a storage medium H such as a computer-readable hard disk (HD), flexible disk (FD), compact disk (CD), magneto-optical disk (MO), or memory card, and installed from the storage medium H into the control unit 60.

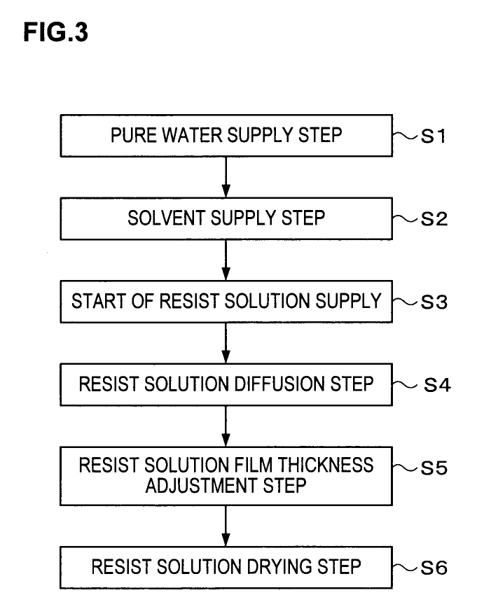

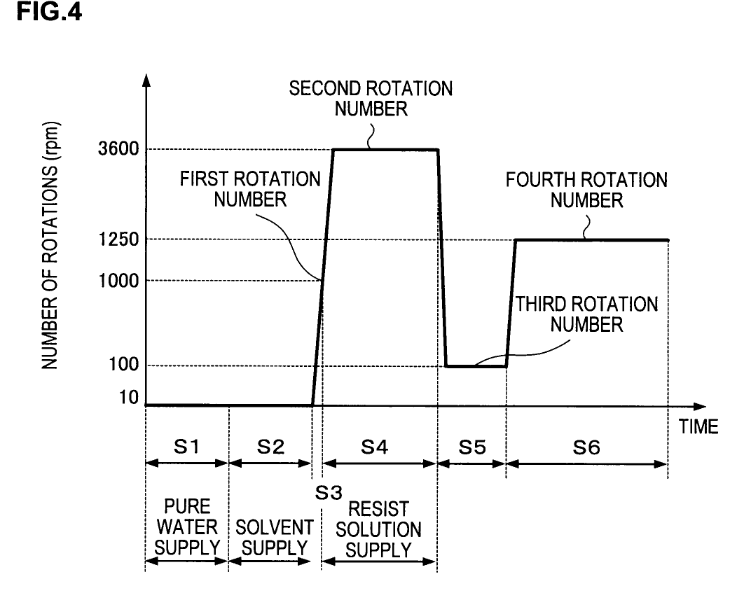

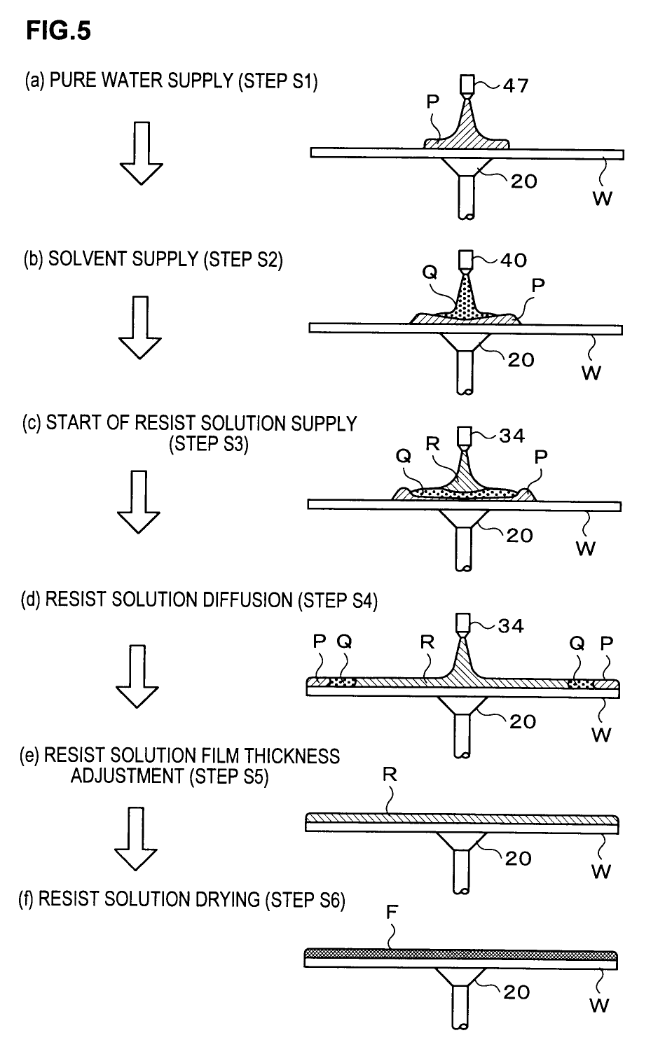

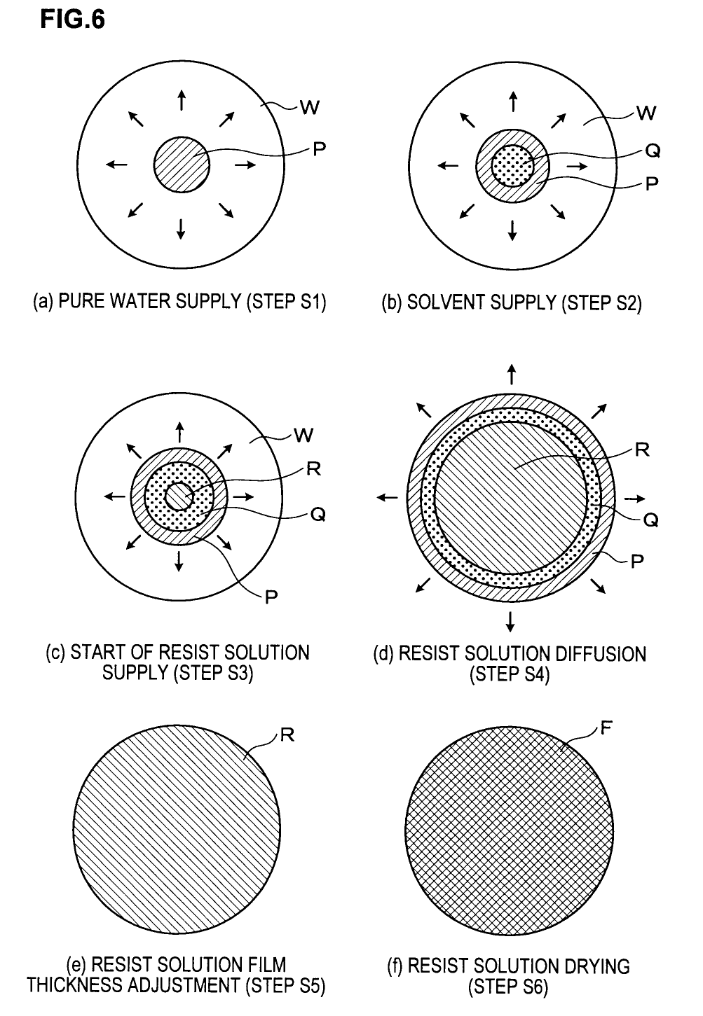

Next, the coating treatment process performed in the resist coating apparatus 1 configured as described above will be described. FIG. 3 is a flowchart showing main steps of the coating treatment process in the resist coating apparatus 1. FIG. 4 is a graph showing the numbers of rotations of the wafer W and the supply timings of the pure water, the solvent and the resist solution in the steps of the coating treatment process. FIG. 5 and FIG. 6 schematically show the state of a solution film on the wafer W in each of the steps of the coating treatment process, FIG. 5 showing the appearance viewed from the side of the wafer W, and FIG. 6 showing the appearance viewed from directly above the wafer W. Note that the lengths of time of the process in FIG. 4 do not necessarily correspond to the actual lengths of time for easy understanding of the technique.

The wafer W transferred in the resist coating apparatus 1 is first suction-held on the spin chuck 20. Subsequently, the pure water nozzle 47 at the waiting section 49 is moved by the third arm 33 to the position above the central portion of the wafer W. At this moment, the solvent nozzle 40 is waiting at the waiting section 42, and the resist solution nozzle 34 is waiting at the waiting section 36. Then, with the wafer W stopped, a pure water P is supplied from the pure water nozzle 47 to the central portion of the wafer W as shown in (a) of FIG. 5 (Step S1 in FIG. 3 and FIG. 4). The pure water P is supplied in a manner that the pure water P does not diffuse on the entire surface of the wafer W as shown in (a) of FIG. 6. The pure water P supplied on the wafer W diffuses concentrically with the wafer W because of its high surface tension.

After the supply of the pure water P is finished, the pure water nozzle 47 is moved from the position above the central portion of the wafer W to the waiting section 49. Concurrently, the solvent nozzle 40 at the waiting section 42 is moved by the second arm 32 to the position above the central portion of the wafer W.

Subsequently, with the wafer W stopped, a solvent Q is supplied from the solvent nozzle 40 to a central portion of the pure water P on the wafer W as shown in (b) of FIG. 5 (Step S2 in FIG. 3 and FIG. 4). The solvent Q has a surface tension lower than that of the pure water P and therefore diffuses on the wafer W behind the pure water P in the diffusion direction (arrows in the drawing) at all times as shown in (b) of FIG. 6. In other words, the solvent Q never runs over the pure water P to diffuse on the wafer W.

After the supply of the solvent Q is finished, the solvent nozzle 40 is moved from the position above the central portion of the wafer W to the waiting section 43. Concurrently, the resist solution nozzle 34 at the waiting section 36 is moved by the first arm 31 to the position above the central portion of the wafer W. Further, in concurrently with the completion of the supply of the solvent Q, the wafer W is rotated at an increased speed as shown in FIG. 4.

When the number of rotations of the wafer W reaches, for example, 1000 rpm to 2000 rpm that is a first rotation number, 1000 rpm in this embodiment, supply of the resist solution R is started from the resist solution nozzle 34 onto the solvent Q as shown in (c) of FIG. 5 and (c) of FIG. 6 (Step S3 in FIG. 3 and FIG. 4).

Subsequently, the rotation of the wafer W is increased, for example, to 2000 rpm to 4000 rpm that is a second rotation number, 3600 rpm in this embodiment, and thereafter the wafer W is rotated at the second rotation number. In this event, the resist solution R is kept supplied from the resist solution nozzle 34 as shown in (d) of FIG. 5. In the case where the wafer W is rotated at a high speed at the second rotation number as described above, the pure water P and the solvent Q diffuse on the wafer W as shown in (d) of FIG. 6, and the resist solution R is led by the solvent Q to diffuse on the wafer W (Step S4 in FIG. 3 and FIG. 4). The solvent Q allows the resist solution to easily diffuse on the wafer W, so that the resist solution R can smoothly and uniformly diffuse on the entire surface of the wafer W. Further, the pure water P, the solvent Q and the resist solution R diffuse concentrically the wafer W in this order in a manner that the resist solution R is never mixed with the pure water P.

After the resist solution R diffuses on the entire surface of the wafer W, the rotation of the wafer W is decreased, for example, to 50 rpm to 500 rpm that is a third rotation number, 100 rpm in this embodiment as shown in FIG. 4. During the rotation of the wafer W at the third rotation number as described above, a force directing to the center is exerted on the resist solution R on the wafer W, whereby the film thickness of the resist solution R on the wafer W is adjusted as shown in (e) of FIG. 5 and (e) of FIG. 6 (Step S5 in FIG. 3 and FIG. 4).

After the film thickness of the resist solution R on the wafer W is adjusted, the rotation of the wafer W is increased, for example, to 1000 rpm to 2000 rpm that is a fourth rotation number, 1250 rpm in this embodiment as shown in FIG. 4. During the rotation of the wafer W at the fourth rotation number as described above, the resist solution R diffused on the entire surface of the wafer W is dried as shown in (f) of FIG. 5 and (f) in FIG. 6, whereby a resist film F is formed (Step S6 in FIG. 3 and FIG. 4).

According to the above embodiment, since the pure water P is supplied onto the wafer W and the solvent Q having a surface tension lower than that of the pure water P is then supplied onto the pure water P, the pure water P suppresses the diffusion of the solvent Q and diffuses on the wafer W ahead of the solvent Q in the diffusion direction at all times. Further, since the pure water P has a high surface tension, the pure water P supplied on the central portion of the wafer W diffuses concentrically with the wafer W. Then, the pure water P and the solvent Q diffuse in this order concentrically with the wafer W. Since the resist solution R is subsequently supplied onto the solvent Q, the resist solution R is led by the solvent Q to smoothly diffuse on the wafer W. This makes it possible to uniformly apply the resist solution R within the wafer W. Further, the pure water P, the solvent Q, and the resist solution R can diffuse in this order concentrically with the wafer W, so that the supply amount of the resist solution R can be reduced, for example, as compared to the case where the resist solution does not diffuse concentrically with the wafer as in the prior art.

Further, since the solvent Q exists between the pure water P and the resist solution R, the resist solution R is never mixed with the pure water P. Accordingly, it is possible to suppress solidification of the resist solution by the pure water as in the prior art, thus further reducing the supply amount of the resist solution R. Note that when the inventors supplied the resist solution R to the wafer W by the coating treatment method of this embodiment, it was found that the supply amount of the resist solution R can be reduced to about half as compared to the coating treatment method in the prior art.

The pure water P is supplied to the central portion of the wafer W in a manner that the pure water P does not diffuse on the entire surface of the wafer W, thus ensuring that even when the solvent Q and the resist solution R are supplied onto the wafer W in order, the solvent Q and the resist solution R can be made to diffuse behind the pure water P in the diffusion direction. This allows the resist solution R to surely diffuse concentrically with the wafer W.

Since the wafer W is rotated at the third rotation number at a low speed after the resist solution R diffuses on the entire surface of the wafer W, a force directing to the center is exerted on the resist solution R on the wafer W, whereby the film thickness of the resist solution R can be adjusted

Though the case using the pure water P as the treatment solution has been described in the above embodiment, a liquid having a surface tension higher than that of the solvent Q, for example, γ-butyrolactone may be used as the treatment solution. For the resist solution R as the coating solution, KrF resist, EUV resist or the like may be used. Further, though the case using the resist solution R as the coating solution containing an organic solvent has been described, for example, a bottom anti-reflection film (BARC: Bottom Anti-Reflection Coating) may be used as the coating solution.

Though the pure water P and the solvent Q are supplied onto the wafer W with the wafer W stopped in Step S1 and Step S2 in the above embodiment, the wafer W may be rotated at a low speed, for example, at a number of rotation of 50 rpm or less. In this case, a centrifugal force can be exerted on the pure water P by the rotation of the wafer W at the low speed to make a peripheral portion of the pure water P higher than its central portion such that the central portion of the front surface of the pure water P is recessed downward. Thus, when the solvent Q is thereafter supplied to the central portion of the pure water P, the solvent Q can be held in the recessed portion of the pure water P. Accordingly, it is possible to surely prevent the solvent Q from flowing out of the pure water P. Further, the optimal numbers of rotations can be set to the above-described first to fourth rotation numbers according to the kinds of the treatment solution and the coating solution in use, the film thickness and so on.

Incidentally, on the investigation by the inventors, it was found that after the supply of the solvent, the resist solution supplied on the solvent possibly diffuses concentrically with the wafer without supply of the pure water described in the above embodiment. Further investigation showed that whether or not the resist solution diffuses concentrically with the wafer depends on the combination of the kind of the solvent and the kind of the resist solution. For example, if cyclohexanone is used for the solvent, the resist solution diffuses concentrically with the wafer without supply of the pure water described in the above embodiment.

Hence, the way that the resist solution R diffuses when only the solvent Q and the resist solution R which will be actually used are applied may be inspected before Step S1 in the above embodiment is performed. In this case, an image capturing unit 70 which captures an image of the front surface of the wafer is provided in the resist coating apparatus 1. The image capturing unit 70 is provided at a ceiling portion of the treatment container 10 to face the wafer suction-held on the spin chuck 20. Further, for the image capturing unit 70, for example, a wide-angle CCD camera is used. Note that the remaining configuration of the resist coating apparatus 1 is the same as the configuration of the resist coating apparatus 1 in the above-described embodiment and therefore description thereof will be omitted.

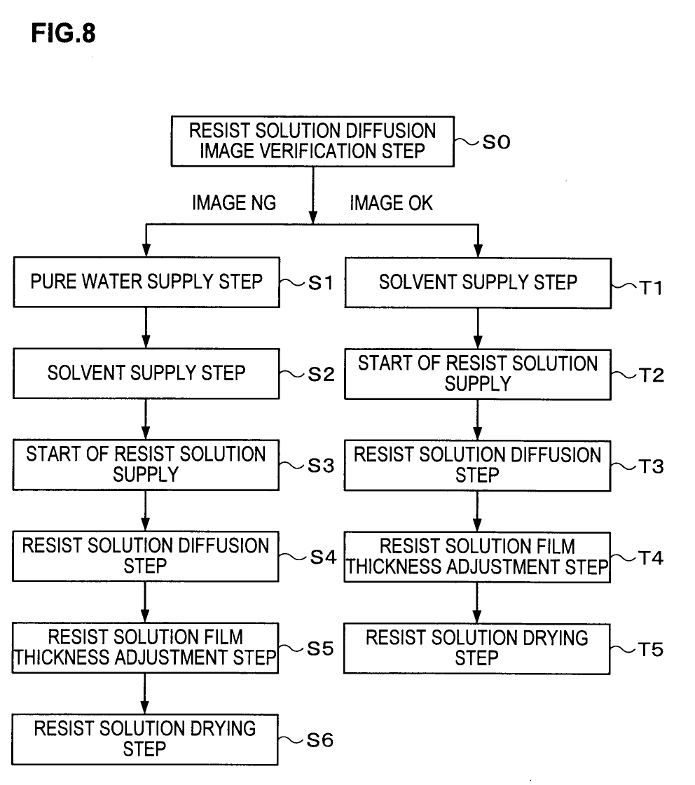

Next, the coating treatment of applying the resist solution R onto the wafer W using the resist coating apparatus 1 will be described in conjunction with inspection processing on an inspection wafer W′ as an inspection substrate. FIG. 8 is a flowchart explaining inspection processing steps for the inspection wafer W′ and the coating treatment steps for the wafer W.

First, the way that the resist solution R diffuses when only the solvent Q and the resist solution R are applied onto the inspection wafer W′ will be inspected. The inspection wafer W′ transferred into the resist coating apparatus 1 is suction-held on the spin chuck 20. Subsequently, with the inspection wafer W′ stopped or rotated at a low speed, for example, at a number of rotations of 50 rpm or less, the solvent Q is supplied to the central portion of the inspection wafer W′ from the solvent nozzle 40. Then, the rotation of the inspection wafer W′ is increased to the second rotation number, and the resist solution R is supplied to the central portion of the solvent Q from the resist solution nozzle 34. Thereafter, the resist solution R is diffused on the inspection wafer W′, while the inspection wafer W′ is rotated at the second rotation number. After a lapse of a predetermined time, the rotation of the inspection wafer W′ is stopped, and an image of the front surface of the inspection wafer W′ is captured by the image capturing unit 70. The image of the front surface of the inspection wafer W′ is outputted from the image capturing unit 70 to the control unit 60. In the control unit 60, the way that the resist solution R on the inspection wafer W′ diffuses is verified based on the inputted image (Step S0 in FIG. 8). Meanwhile, when the image of the front surface of the inspection wafer W′ is captured, the inspection wafer W′ is transferred out of the resist coating apparatus 1. Note that the image of the front surface of the inspection wafer W′ is captured after the rotation of the inspection wafer W′ is stopped, but the image may be captured by the image capturing unit 70 during the rotation of the inspection wafer W′.

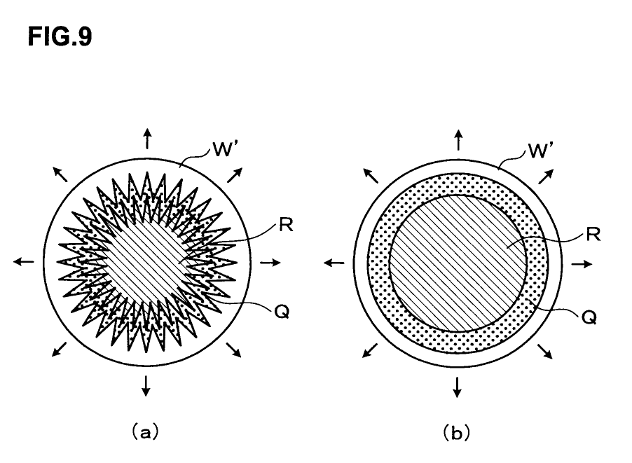

If the control unit 60 verifies that the resist solution R has not diffused concentrically with the inspection wafer W′, for example, as shown in (a) of FIG. 9, a wafer W subsequently transferred into the resist coating apparatus 1 is subjected to the above-described Steps S1 to S6. More specifically, the pure water P, the solvent Q and the resist solution R are supplied in this order onto the wafer W, whereby the resist solution R is applied on the wafer W (Steps S1 to S6 in FIG. 8).

On the other hand, if the control unit 60 verifies that the resist solution R has diffused concentrically with the inspection wafer W′, for example, as shown in (b) of FIG. 9, the supply of the pure water P in the above-described Step S1 can be omitted. In this case, the solvent Q is first supplied from the solvent nozzle 40 to the central portion of the wafer W suction-held on the spin chuck 20 (Step T1 in FIG. 8). The supply of the solvent Q may be performed with the rotation of the wafer W stopped or the wafer W being rotated at a low speed, for example, at a number of rotations of 50 rpm or less. Then, the rotation of the wafer W is increased to the second rotation number, and the resist solution R is supplied to the central portion of the solvent Q from the resist solution nozzle 34 (Step T2 in FIG. 8). When the number of rotations of the wafer W reaches the second rotation number, then the wafer W is rotated at the second rotation number so that the resist solution R diffuses on the wafer W. In this event, the resist solution R is kept supplied from the resist solution nozzle 34 (Step T3 in FIG. 8). Once the resist solution R has diffused on the entire surface of the wafer W, the film thickness of the resist solution R on the wafer W is then adjusted (Step T4 in FIG. 8), and the resist solution R is dried (Step T5 in FIG. 8). Note that these Steps T4 and T5 are performed in the same recipes as those of the above-described Steps S5 and S6.

According to the above embodiment, the resist solution R can be made to diffuse concentrically with the wafer W irrespective of whether or not the resist solution R diffuses concentrically with the inspection wafer W′ in Step S0. Further, if it is verified that the resist solution R diffuses concentrically with the inspection wafer W′ is verified in Step S0, Step S1 in the above-described embodiment, that is, the supply of the pure water P can be omitted, thereby improving the throughput of the coating treatment of the wafer W.

In the above embodiment, the relation between the way that the resist solution R diffuses verified in Step S0 and the combination of the resist solution R and the solvent Q may be held in the control unit 60. In this case, where the resist solution R is applied to a new wafer W thereafter, Step S0 becomes unnecessary to be performed if the combination of the resist solution R and the solvent Q which are used in the coating treatment is the same as the combination held in the control unit 60. More specifically, the way that the resist solution R diffuses is recognized based on the relation held in the control unit 60, so that either Steps S1 to S6 to be performed or Steps T1 to T5 to be performed on the wafer W can be automatically selected. Note that if the combination of the resist solution R and the solvent Q which are used in the coating treatment for the new wafer W is not the same as the combination held in the control unit 60, either Steps S1 to S6 or Steps T1 to T5 are performed after Step S0 described in the above embodiment is performed.

Preferred embodiments of the present invention have been described above with reference to the accompanying drawings, but the present invention is not limited to the embodiments. It should be understood that various changes and modifications are readily apparent to those skilled in the art within the scope of the spirit as set forth in claims, and those should also be covered by the technical scope of the present invention. The present invention is not limited to the examples but can take various forms. The present invention is also applicable to the coating treatment on other substrates such as an FPD (Flat Panel Display), a mask reticle for a photomask, and the like other than the wafer.

The present invention is useful in applying a coating solution containing an organic solvent on a substrate, for example, a semiconductor wafer or the like.

What is claimed is:

1. A coating treatment method of applying a coating solution containing an organic solvent onto a substrate, said method comprising:
a first step of supplying a treatment solution having a first surface tension to a central portion of the substrate;
a second step of subsequently supplying a solvent for the coating solution to a central portion of the treatment solution supplied in said first step, said solvent having a second surface tension lower than the first surface tension; and
a third step of subsequently supplying the coating solution to a central portion of the solvent supplied in said second step while rotating the substrate to diffuse the treatment solution and the solvent on the substrate to thereby diffuse the coating solution on an entire surface of the substrate.

2. The coating treatment method as set forth in claim 1,
wherein in said first step, the treatment solution is supplied to the central portion of the substrate in a manner that the treatment solution does not diffuse on the entire surface of the substrate.

3. A method of applying a coating solution containing an organic solvent onto a substrate,
wherein before the coating solution is applied onto the substrate, a solvent for the coating solution is supplied onto an inspection substrate, the coating solution is then supplied to a central portion of the solvent supplied on the inspection substrate while rotating the inspection substrate, and a way that the coating solution diffuses on the inspection substrate is inspected, and
if that the coating solution does not diffuse concentrically with the inspection substrate is verified,
a first step of supplying a treatment solution having a first surface tension to a central portion of the substrate;
a second step of subsequently supplying the solvent for the coating solution to a central portion of the treatment solution supplied in said first step, said solvent having a second surface tension lower than the first surface tension; and
a third step of subsequently supplying the coating solution to a central portion of the solvent supplied in said second step while rotating the substrate to diffuse the treatment solution and the solvent on the substrate to thereby diffuse the coating solution on an entire surface of the substrate, are performed.

4. The coating treatment method as set forth in claim 3,
wherein the inspection of the way that the coating solution diffuses is performed by capturing an image of the coating solution on the substrate.

5. A computer-readable storage medium storing a program running on a computer of a control unit which controls a coating treatment apparatus in order to cause the coating treatment apparatus to execute a coating treatment method of applying a coating solution containing an organic solvent onto a substrate,
said coating treatment method comprising:
a first step of supplying a treatment solution having a first surface tension to a central portion of the substrate;
a second step of subsequently supplying a solvent for the coating solution to a central portion of the treatment solution supplied in said first step, said solvent having a second surface tension lower than the first surface tension; and
a third step of subsequently supplying the coating solution to a central portion of the solvent supplied in said second step while rotating the substrate to diffuse the treatment solution and the solvent on the substrate to thereby diffuse the coating solution on an entire surface of the substrate.

6. A coating treatment apparatus for applying a coating solution containing an organic solvent onto a substrate, said apparatus comprising:
a treatment solution nozzle for supplying a treatment solution having a first surface tension to the substrate;
a solvent nozzle for supplying a solvent for the coating solution to the substrate, said solvent having a second surface tension lower than the first surface tension;
a coating solution nozzle for supplying the coating solution to the substrate;
a rotating and holding unit for holding the substrate and rotating the substrate at a predetermined speed; and
a control unit for controlling said treatment solution nozzle, said solvent nozzle, said coating solution nozzle, and said rotating and holding unit to execute a first step of supplying the treatment solution having the first surface tension to a central portion of the substrate; a second step of subsequently supplying the solvent for the coating solution having the second surface tension lower than the first surface tension to a central portion of the treatment solution supplied in said first step; and a third step of subsequently supplying the coating solution to a central portion of the solvent supplied in said second step while rotating the substrate to diffuse the treatment solution and the solvent on the substrate to thereby diffuse the coating solution on an entire surface of the substrate.

7. The coating treatment apparatus as set forth in clam 6,
wherein in said first step, said control unit controls said treatment solution nozzle and said rotating and holding unit in a manner that the treatment solution does not diffuse on the entire surface of the substrate.
